(19) United States
(12) Patent Application Publication
(10) Pub. No.: US 2009/0309706 A1
(43) Pub. Date: Dec. 17, 2009

(54) RADIO FREQUENCY IDENTIFICATION SYSTEM WITH IMPROVED ACCURACY AND DETECTION EFFICIENCY IN PRESENCE OF CLUTTER

(76) Inventors: Somnath Mukherjee, Milpitas, CA (US); Ashis Khan, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/482,410

(22) Filed: Jun. 10, 2009

Related U.S. Application Data
(60) Provisional application No. 61/131,765, filed on Jun. 11, 2008.

(51) Int. Cl. H04B 7/00

(52) U.S. Cl. 340/10.1

(57) ABSTRACT

A technique that improves performance of passive backscatter RFID tags such as mitigation of read error in presence of clutter, provide enhanced range, speed up anti-collision reading, provide increased throughput etc. The technique utilizes amplitude and phase modulation at the tag and a compensation algorithm at the RFID reader without inflicting significant changes in the RFID chip and therefore has minimum cost impact. Modifications can be primarily in the antenna design and passive circuitry around it, printable by a single step process.

### CROSS-REFERENCES TO RELATED APPLICATIONS

This application claims the benefit of U.S. Provisional Application No. 61/131,765, filed Jun. 11, 2008, hereby incorporated by reference in its entirety for all purposes.

### BACKGROUND OF THE INVENTION

1. Field of the Invention

The present disclosure relates generally to the field of electrical communications and radio wave antennas as well as remotely monitoring identification devices using electromagnetic waves. More particularly, it relates to the field of radio frequency identification (RFID) devices, sometimes called tags, in which a tag is interrogated by a probing platform, sometimes called a reader. Even more particularly, it relates to the field of radio frequency identification tags that allows phase modulation or a variation thereof (e.g. phase shift keying) in addition to amplitude modulation for the tag-to-reader communication. Even more particularly, it relates the field of radio frequency identification systems employing advanced techniques such that undesired clutter from non-tag items can be mitigated using a compensation technique.

2. Description of the Related Art

Radio-frequency Identification Devices (RFID) are used in multiple asset tracking applications, e.g., automotive, airline baggage, consumer items, food items, garments, livestock etc. There are numerous medical and military applications too. Many RFID tags do not use a battery for power. These types of RFID tags predominantly use the principle of “passive backscatter” while employing a semiconductor chip that converts part of the received radio-frequency (RF) to DC power to energize the chip itself, as described in common literature such as K. Finkenzeller, RFID Handbook: Fundamentals and Applications in Contactless Smart Cards and Identification, 2^{nd} ed. (San Francisco, Calif.: John Wiley & Sons, 2003). The RFID ecosystem operates in multiple bands, e.g., low frequency (LF), high frequency (HF), ultra high frequency (UHF) and microwaves and usually employs amplitude shift keying (ASK) (or variations thereof) on the backscatter from the tag to carry the information embedded in the tag to the reader. LF and HF systems commonly operate under near-field conditions and have a limited range of 1 meter or so, whereas UHF and microwave tags predominantly operate under far-field conditions and are usually capable of longer range and higher data rates, as described in Smail Tedjini et al., “Antennas for RFID Tags” (Grenoble, France: Joint sOc-EUSAI Conference, October 2005). The modulation and coding formats are defined by various standards such as EPCglobal Class 0, Class 1, Gen II, etc. for UHF tags.

A passive backscatter tag does not transmit its own signal to the reader but simply modulates the signal that its antenna backscatters by changing the impedance presented to the antenna. In this fashion, the tag need only provide a switching function operating at a modest rate comparable to the data rate of a few hundred kbps, as described in D. Dobkin et al, “A Radio-Oriented Introduction to Radio Frequency Identification,” High Frequency Electronics, June 2005. A typical UHF RFID tag uses a dipole antenna (or a variation thereof) and is switched between open circuit and a matched load. In other words, the data from tag to reader is sent by amplitude modulating the radar cross section (RCS) during the time interval that the tag receives a continuous wave (CW) signal from the reader.

The performance of the tag to reader link is limited due to the amplitude modulated nature of the signal. Amplitude modulated signals usually require higher signal to noise ratios than the phase modulated counterparts like phase-shift keying (PSK). A PSK system will therefore provide longer range and be more tolerant to multipath fades. Moreover, a multiple level PSK system can be used to speed up the anti-collision reading process by assigning unique phase states to different categories of tags. Also, a phase modulation based system ideally can scatter back all the energy captured by the tag from the reader, minus the amount converted to DC. Furthermore, it does not require a precise impedance matching as commonly required in ASK systems.

ASK based systems suffer major limitations in the presence of reflected and scattered clutter from non-tag items, as well as leakage of reader transmissions into the reader receiver.

Using coherent PSK detection at the reader, and adding a compensation scheme, it is possible to separate these impairments from the desired backscatter from the tag. However, conventional methods to create phase modulated backscatter increases the complexity of the chip inside the tag and thereby increase cost.

A major obstacle in successful deployment of RFID tags is the lack of ability of detecting multiple RFID tags accurately by an RFID reader in a cluster. For example, an RFID reader may be asked to read 100 items in a supermarket cart with all of the items having RFID tags. Existing RFID systems have poor accuracy in accurately detecting all such IDs in parallel due to clutter.

Thus, a better solution is needed to extend the range of RFID tags, make operation robust in multipath situations, mitigate the effect of clutter and speed up reading among a cluster.

### BRIEF SUMMARY OF THE INVENTION

Embodiments in accordance with the present disclosure relate to remote identification devices that illuminate a radio frequency identification (RFID) device (e.g., an RFID tag) with electromagnetic waves and coherently process the backscatter, the RFID devices according to various embodiments are capable of introducing amplitude and or phase modulation on the backscattered signal with an on/off (i.e. single pole single throw) switch, and an interrogator is equipped with a correction algorithm to mitigate the effect of clutter resulting from reflection/scattering from items containing electrical conductors (metal) or high dielectric constant such as water based liquids, as is common in a supermarket cart. Additional benefits are longer range, enhanced read speed in a cluster of devices (anti-collision reading) and enhanced throughput.

Passive backscatter RFID tags can receive a continuous wave (CW) signal from a reader or interrogator and convert a part of the wave into direct current (DC) used to power a chip inside the tag. The chip in the RFID tag decodes the information sent out by the reader and prepares a response. The response is a bit stream generated by impedance modulating the tag antenna.

One embodiment relates to a method of impedance modulation of a passive backscatter radio frequency identification (RFID) tag. The method includes receiving a wireless input signal into an antenna of an RFID tag, the antenna having a characteristic impedance and being operatively connected to a switch, switching the switch between a first circuit having a first impedance and a second circuit having a second impedance such that an output signal from the antenna is modulated both in a predetermined amplitude and a predetermined phase, the modulation in both the predetermined amplitude and the predetermined phase corresponding to a device signature of the RFID tag, and emitting the output signal from the RFID tag.

Another embodiment relates to a machine-implemented method of discerning a radio frequency identification (RFID) tag among non-RFID tag clutter. The method includes receiving a wireless signal into a reader antenna, the wireless signal including an emitted signal from an RFID tag and complex clutter, estimating an amplitude and phase of the signal in two or more distinct states, estimating an amplitude and phase of the complex clutter, and subtracting the complex clutter from the received signal.

Yet another embodiment relates to a passive backscatter radio frequency identification (RFID) tag. The tag includes a patch element, a switch connected to the patch element, and at least one circuit, each of the at least one circuit having a distinct predetermined impedance. The switch is adapted to switch an electrical connection between the patch element and the at least one circuit such that the RFID tag emits a predetermined pattern of signals when illuminated by an RFID interrogator, the pattern of signals corresponding to a device signature of the RFID tag.

The foregoing has outlined, in general, the physical aspects of the invention and is to serve as an aid to better understanding the more complete detailed description that is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration the advantages and objects of the present invention.

FIG. 1 illustrates how a reflection coefficient of a passive network at an antenna port can change the relative amplitude and phase of a backscattered signal in accordance with an embodiment.

FIG. 2 shows a two-port representation of a non minimum scatter antenna in accordance with an embodiment.

FIG. 3 describes a basic principle of a tag in accordance with an embodiment in which the tag antenna port is switched between N (where N≧2) passive networks.

FIG. 4 depicts a microstrip patch as a candidate for the tag antenna possessing the requisite property (non minimum scatter) described in FIG. 1.

FIG. 5 shows a schematic for a preferred embodiment for generating binary phase shift keying (BPSK).

FIG. 6 shows a schematic for a preferred embodiment for generating quadrature phase shift keying (QPSK).

FIG. 7 is a phasor diagram illustrating how differential phase shift can be utilized to recover tag modulation in accordance with an embodiment, even in presence of heavy impairments (clutter).

FIG. 8 is a plot from mathematical modeling depicting a differential phase shift as a function of clutter phase angle for 180° and 90° keying, in accordance with an embodiment.

FIG. 9 depicts logic followed in an embodiment of the reader to recover tag modulation in presence of heavy impairments (clutter) in accordance with an embodiment.

FIG. 10 depicts an algorithm for mitigating impairments (clutter) in accordance with an embodiment.

FIG. 11 illustrates an RFID reader and tag in accordance with an embodiment.

The figures will now be used to illustrate different embodiments in accordance with the invention. The figures are specific examples of embodiments and should not be interpreted as limiting embodiments, but rather exemplary forms and procedures.

### DETAILED DESCRIPTION OF THE INVENTION

The present disclosure describes a novel technique and apparatus for modulating a backscattered signal from a radio frequency identification (RFID) device or tag. This technique does not require changes to the chip architecture inside an RFID tag. Generally, the only changes that are needed are within the tag antenna and associated circuitry. Because the tag antenna and associated circuitry can be fabricated using the same process as a typical tag antenna (e.g. single step printing) there is almost no additional cost to the tag.

This novel technique modulates the phase of a backscattered signal in addition to the amplitude. In one embodiment, this is implemented through connecting the antenna to relatively low cost and simple circuits that are external to the antenna through a switch. In another embodiment, low cost and simple circuits are integrated within the antenna.

To achieve control over both amplitude and phase modulation of the backscattered signal, a special category of antennas that scatters back a negligible quantity of signal energy when terminated by its characteristic impedance is used. These types of antennas almost invariably include at least one parasitic element in addition to the main element and may be termed “non-minimum scatter antennas” (see Mukherjee, S., “Antennas for Chipless Tags Based On Remote Measurement of Complex Impedance,” Proceedings of the 38th European Microwave Conference (Amsterdam, 2008)). The residual scattered power, under matched condition is due to structural scattering. By proper design, the structural scattering can be minimized.

One type of non-minimum scatter antenna is a “non-dipole antenna” because a dipole antenna is generally not suitable as a non-minimum scatter antenna. A non-dipole antenna generally can create a backscatter even when terminated by an external, lossless network, such as an open circuit or a short circuit.

The magnitude and phase of the scattered signal can be controlled by the mismatch between the antenna characteristic impedance and a passive external termination. Therefore, by proper selection of two (or more) passive networks connected through a switch to the antenna, amplitude and phase modulation of the backscatter is achieved.

If the external termination is (ideally) lossless, only the phase of the scattered signal is modulated. In this special case, a phase-shift keyed (PSK) system would be implemented. If the external network also includes a dissipative or resistive part in addition to a reactive part, both amplitude and phase modulations (e.g. quadrature amplitude modulation (QAM)) are achieved.

A received signal at a reader undergoes signal processing with an algorithm that uses the amplitude and phase information from the tag to mitigate the effect of clutter, usually coming from reflection scattering from metallic objects, water based liquids and leakage from the reader's transmit antenna.

There are several advantages to this technique. A PSK signal will operate with substantially lower received power than amplitude shift keying (ASK) and therefore increase the range of operation of the reader and tag. The system can be more frugal in utilizing the captured radio frequency (RF) power at the tag. Except for the power converted to direct current (DC), generally all power is scattered back to the reader. This is unlike RFID dipole antennas in which half the power is dissipated in the antenna during the ‘mark’ mode (no power scattered back during ‘space’ at all). Because the RFID device using PSK is more frugal with the power, this can allow operation with less power transmitted from the reader. This can reduce interference, help to comply with local regulatory standards, etc. Critical impedance matching between the tag antenna and the chip is not required since the antenna is operating almost always in mismatched condition for a PSK operation. Tags almost always operate in the presence of clutter coming from reflection/scattering from non-tag items and leakage from the transmit antenna of the reader. It is possible to mitigate the effect of this clutter by use of a compensation scheme described. It is possible to speed up an anti-collision read mechanism by creating several categories of tags and each category imbibed with unique phase states. Also, the tag to reader data rate can be increased through the use of an m-QAM system

Though Phase Shift Keying (PSK) is mentioned in the EPCglobal Gen II standard for Tag to Reader communication (see EPC Radio-Frequency Identity Protocols Class-1 Generation-2 UHF RFID Protocol for Communications at 860 MHz-960 MHz, version 1.1.0 (EPCglobal Inc., Dec. 17, 2005), section 6.3.1.3.1 on p. 27), usually various forms of Amplitude Shift Keying (ASK) are used due to simplicity of implementation. Amplitude shift keying of the backscatter is implemented by alternately terminating the tag antenna with its characteristic impedance and opening it. In other words, the radar cross section (RCS) of the tag undergoes amplitude modulation.

Several issues are evident from this disclosure:
1. It is possible to design certain class of antennas that ideally scatter back the entire signal captured provided the termination is purely reactive. An example is microstrip patch and a counter-example is a dipole.
2. The above category of antennas scatters back a negligible quantity of signals when terminated by the antennas' characteristic impedances. The residual scattered power under such conditions can be called structural scattering. By proper design, the structural scattering can be minimized. This type of antenna can be termed a non minimum scatter antenna.
3. The magnitude of the scattered signal can be controlled by the mismatch between the antenna characteristic impedance and the external termination.
4. The phase of the scattered signal can be controlled by the reactive part of the external network.
5. By the use of a switch to switch between two or more external networks, it is possible to control amplitude and phase of backscattered signals for multiple states. It is therefore not necessary to construct a separate amplitude/phase modulator in the tag chip.

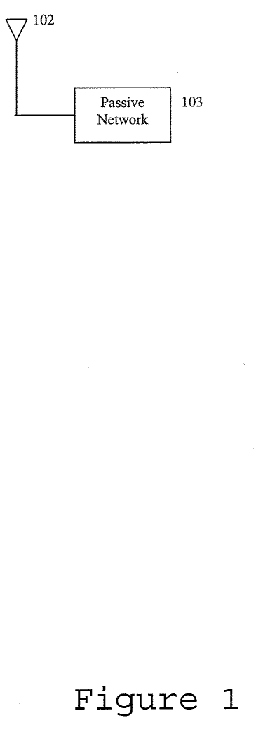

FIG. 1 shows a non-minimum scatter antenna 102 terminated by a passive network 103. Non-minimum scatter antenna 102 is preferably an antenna on an RFID tag. Table 1 below depicts relative amplitude and phase values for the scattered signal for some typical passive networks. For example, a (perfectly) matched termination to antenna 102 results in zero backscatter. For a resistive and reactive network with a reflection coefficient in the Euler complex phasor notation of Ae^{jα}, (where j is the square root of negative 1), the relative amplitude of backscatter is A (where A<1) and the relative phase of the backscatter is α.

TABLE 1

| | Amplitude of | Phase of |
|---|---|---|
| | Backscatter | Backscatter |
| Type of Passive Network | (relative) | (relative) |
| Matched Termination | 0 | n/a |
| Open Circuit | 0 | 0 |
| Short Circuit | 1 | 0 |
| Lossless network of | 1 | φ |
| reflection coefficient 1 · e^{jφ} | | |
| Lossy network of | A | α |
| reflection coefficient A · e^{jα} | | |

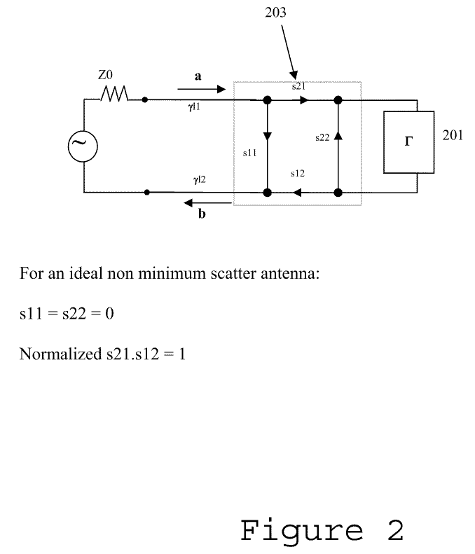

FIG. 2 illustrates passive network 103 of FIG. 1 as passive network 201. Passive network 201 is represented by a reflection coefficient Γ, and the antenna 102 replaced by its equivalent two-port network 203. The source impedance Z0 204 is 120π ohms, i.e. the impedance of free space. The variable a is a transmitted wave, and the variable b is a reflected wave. Variables γ11 and γ12 are propagation functions (i.e. a measure of attenuation and phase shift due to propagation. Variables s11, s12, s21, and s22 are scattering parameters. For an ideal non minimum scatter antenna, s11 and s22 are both zero, and (normalized) s21×s12=1.

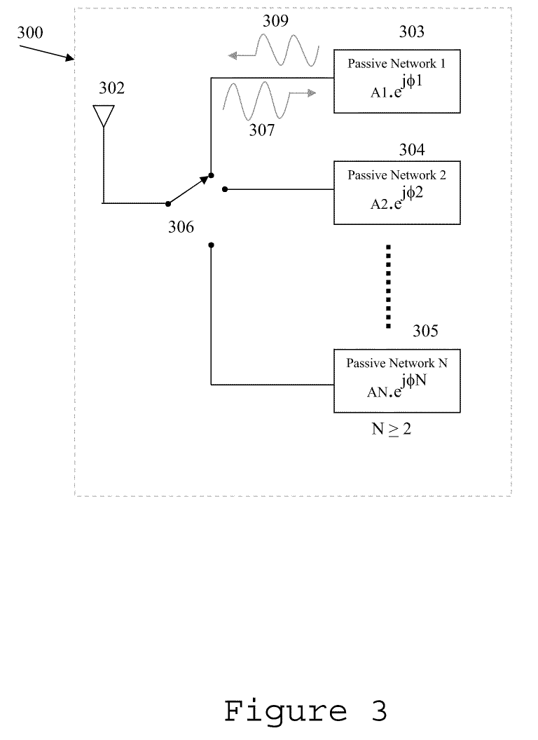

FIG. 3 depicts passive backscatter RFID tag 300 in accordance with an embodiment. Tag 300 has a non minimum scatter antenna 302, which has a characteristic impedance, and an N position (i.e. N-tuple throw) switch 306. N distinct amplitude-phase states can be created by connecting N passive networks 303, 304, . . . 305 to antenna 302 through switch 306. Each passive network operatively connected to the i'th switch position is represented by Aᵢe^{jφi}, which represents a predetermined reflection coefficient resulting from a predetermined impedance.

In the exemplary embodiment, a wireless signal (not shown) is received into antenna 302. Because switch 306 is connected to passive network 303, incident wave 307 travels from antenna 302 to passive network 303. Incident wave 307 is modified by passive network 303 to create a reflected wave 309. Reflected wave 309 travels back through switch 306 and is radiated by antenna 302.

Passive network 303 modifies incident wave 307 by its impedance or impedance mismatch between passive network 303 and antenna 302, such that reflected wave 309 can be represented by A₁e^{jφ1}, where A₁ is the relative amplitude of backscatter and φ1 is the relative phase.

In the special case of Aᵢ=1, the corresponding i'th passive network is lossless. If Aᵢ is essentially equal to 1, then the corresponding passive network is substantially lossless. “Substantially lossless” can include amplitude coefficients within 1%, 5%, 10%, or greater of 1.

Other embodiments can have the ‘reflected’ or modified wave travel through a separate path than that from which it came. The separate path can lead to another antenna, such that the receive antenna is separate from the transmit/emit antenna.

While the wireless signal is received into antenna 302, switch 306 can be switched between passive networks or circuits 303, 304, . . . , 305 such that reflected waves or output signals from each network temporally combine to form an output signal along the common (i.e. left terminal in switch 306), and an output signal from antenna is thus modulated in predetermined amplitude and predetermined phase. The predetermined amplitude/phase modulation corresponds to an identifier, serial number, or other device signature of RFID tag 300. The output signal is emitted from RFID tag 300 through antenna 302.

Switch 306 can be made from transistors, PIN diodes, micromechanical or other switches as known in the art. Solid state switches can be made from silicon, gallium arsenide, or other semiconductor materials.

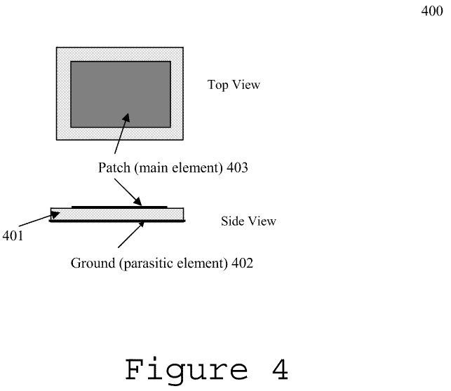

FIG. 4 shows a microstrip patch 400, which is a minimum scatter antenna. Patch 403 is a rectangular piece of conductive material. Circular, triangular, other simple shapes, and more complex, arbitrary patterns can also be used successfully for a patch element. Ground 402 lies in a parallel plane to patch 403, separated by dielectric 401. Dielectric 401 can be made from plastic; low loss dielectric material is preferred. In the exemplary embodiment, patch 403 is the main element in 400 and ground plane 402 may be considered the parasitic element.

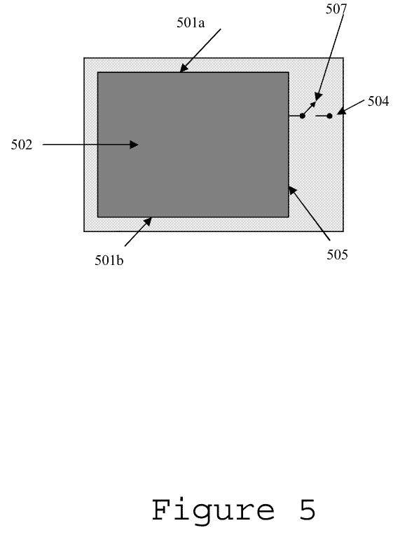

FIG. 5 shows an exemplary scheme for generating a Binary Phase Shift Keyed (BPSK) scattered signal. Patch element 502 is similar to patch element 403 in FIG. 4. Patch element 502 has radiating edges 501a and 501b and non-radiating edge 505. One terminal of on/off switch 507 (i.e. single pole, single throw (SPST) switch) is connected to a point on non-radiating edge 505. The other end of switch 507 is connected to the ground plane (see FIG. 4) through a via hole 504.

While an electromagnetic wave is received into patch element 502, on/off switch 507 is operated to modulate the output signal. The phase of the radar cross section of patch antenna 502, rather than its amplitude, is changed by the switching process. This predetermined modulation corresponds to the identifier of the RFID tag.

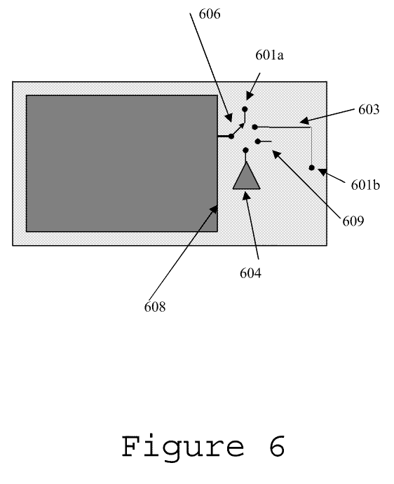

FIG. 6 shows an exemplary scheme for generating a Quaternary Phase Shift Keyed (QPSK) scattered signal. The common terminal of four-position switch 606 (i.e. single pole, quadruple throw switch) is connected to non-radiating edge 608 of the patch. Circuits 601a and 601b are via holes to the ground plane connecting two different positions of 606. Circuit 601a generates a short circuit to ground, whereas circuit 601b is connected through shorted transmission line 603, generating an effective inductance. Transmission line 603 can be a simple transmission line, an inductor component, or other inductor. Terminal or position 609 of switch 606 generates an open circuit. Capacitive stub 604 is connected to the fourth position of 606. The capacitive stub can be a triangle shaped metallic pattern or other metallic patterns on a dielectric. Lumped capacitors can also be used. Therefore, four phase shifts spaced at 90° apart can be generated by this scheme.

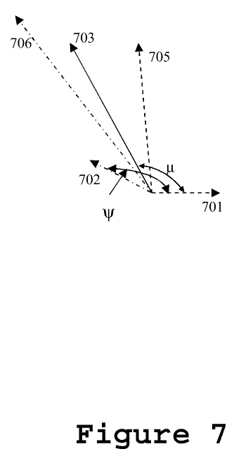

FIG. 7 illustrates how a clutter signal phasor 703 (at the reader) affect a signal from a tag. A ‘low state’ from the RFID tag is represented by the phasor 701 and a ‘high state’ by phasor 702. The resultant signals, as received by the reader are represented by phasors 705 and 706, in the low and high states of the tag respectively.

The following signals can be defined at the reader's receiver as follows (phase shift keyed signal):

s·e^{j0}=signal from the tag alone—low state (e.g. phasor 701); (Eqn. 1)

s·e^{jψ}=signal from the tag alone—high state (e.g. phasor 702); and (Eqn. 2)

m·e^{jμ}=signal from impairments (reflection/scattering from non-tag objects and transmitter leakage) alone (e.g. phasor 703), (Eqn. 3)

where ψ is the phase shift between the low and high states of the tag signal.

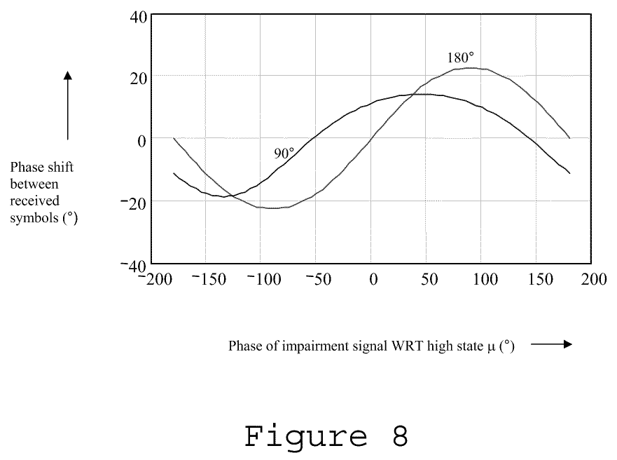

FIG. 8 is a plot generated through mathematical modeling showing how the phase angle ψ between phasor 705 and phasor 706 changes as a function of μ. The phase shift between low and high states ψ is used as a parameter (90° and 180°). m/s=5 was used in this plot.

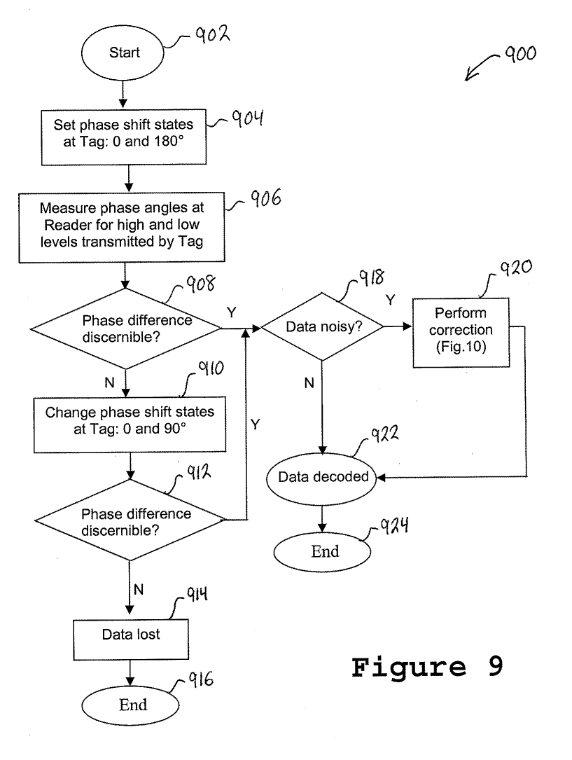

FIG. 9 shows algorithm 900 to distinguish between low and high states from the tag in presence of heavy clutter. After beginning at step 902, the phase shift states are set in step 904 at the tag to 0° and 180°. In step 906, phase angles are measured at the reader for high and low levels emitted by the tag. In step 908, the algorithm determines whether the phase difference between the measured angles is discernible. If it is determined in step 908 that the phase difference is not discernible, then the phase shift states are set at the tag to 0° and 90° in step 910. In step 912, the algorithm determines again whether the phase difference between the measured angles is discernible. If it is determined in step 912 that the phase difference is still not discernible, then the data is presumed lost in step 914 and the algorithm ends at step 916. If the phase difference is discernible either in step 908 or step 912, the algorithm then determines in step 918 whether the data is noisy (e.g. includes clutter). If it is determined that the data is noisy, then a correction is performed in step 920. The data is then decoded in step 922 and the algorithm ends at step 924.

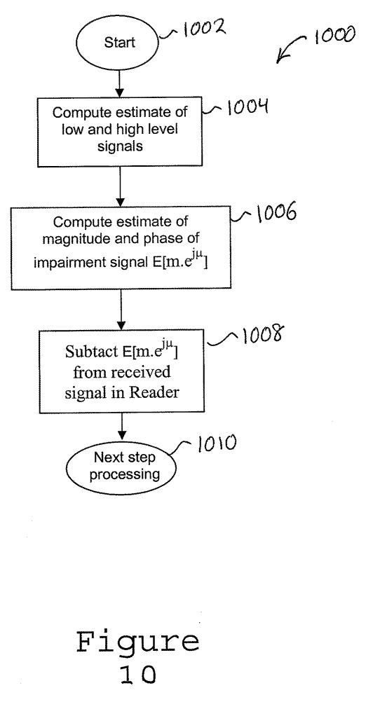

FIG. 10 depicts a correction algorithm 1000 whereby an estimate of the clutter phasor is estimated and subtracted from the received signals at a reader to determine the low and high states from an RFID tag. After beginning at step 1002, step 1004 computes an estimate of low and high level signals. Step 1006 computes an estimate of the magnitude and phase of the impairment signal (e.g. E[m·e^{jμ}]). In step 1008, the estimate is subtracted from the signal received back from the tag. The algorithm then moves on to the next step 1010 of processing.

The estimates of signal at the reader in low and high states of the tag are:

E[L]=E[s·e^{j0}+m·e^{jμ}] (e.g. phasor 705—low level signal); and (Eqn. 4a)

E[H]=E[s·e^{jψ}+m·e^{jμ}] (e.g. phase 706—high level signal). (Eqn. 4b)

Then, E[s]·(1−e^{jψ})=E[L]−E[H], such that:

E[s]=|(E[L]−E[H])/(1−e^{jψ})| (Eqn. 5a)

and

E[m·e^{jμ}]=½[E[L]+E[H]−E[s]·(1+e^{jψ})] (Eqn. 5b)

Therefore, it is possible to calculate E[m·e^{jμ}] from above equations. Afterward, the corrected signal is obtained by subtracting E[m·e^{jμ}] from the received signal.

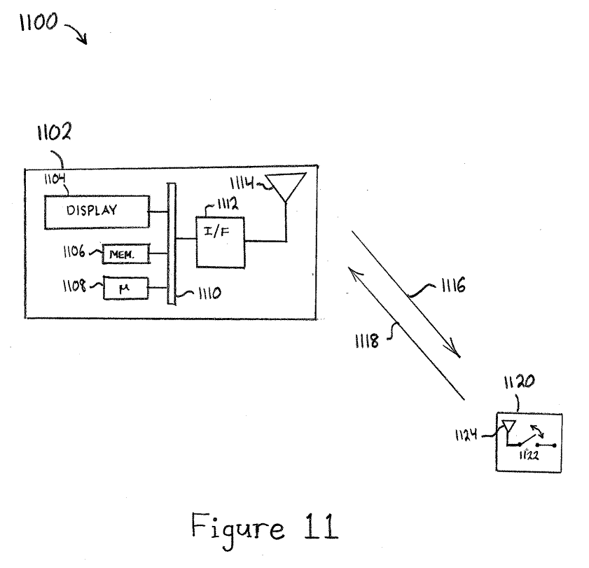

FIG. 11 illustrates system 1100 in which reader 1102 reads a wireless signal from RFID tag 1120. Reader 1102 includes display 1104, memory 1106, microprocessor 1108, and data bus 1110. Reader 1102 also includes reader radio frequency (RF) antenna 1114 connected to the other components through interface 1112. Reader transmits wireless interrogation signal 1116, which is received by RFID tag 1120. In particular, RFID tag antenna 1124 receives the interrogation signal and, through active switching of switch 1122 connecting to two networks (e.g. open circuit and ground circuit), modulates the scattered wireless signal 1118. Reader RF antenna 1114 receives wireless signal 1118. Interface 1112 filters, amplifies, and coherently demodulates the signal. Based on the complex demodulated symbols, the microprocessor 1108 estimates an amplitude and phase of the signal in two or more distinct states (e.g. low and high states of the RFID tag). Microprocessor 1108 then estimates an amplitude and phase of complex clutter received in signal 1118. Microprocessor 1108 then uses the estimate of the amplitude and phase of the complex clutter in the received signal to remove or otherwise subtract complex clutter from the received signal. In this way, microprocessor can determine the corresponding device ID of RFID tag 1120 among other tags and clutter.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

What is claimed is:

1 A passive backscatter radio frequency identification (RFID) tag, comprising:
a non-dipole antenna;
a switch connected to the non-dipole antenna; and
at least one circuit having a predetermined impedance,
the switch adapted to switch an electrical connection between the non-dipole antenna and the at least one circuit such that the RFID tag emits a predetermined pattern of signals when illuminated by an RFID interrogator, the pattern of signals corresponding to a device signature of the RFID tag.

2. The RFID tag of claim 1 wherein the antenna is of an antenna type that emits radio frequency backscatter when the antenna is terminated by a reactive circuit and the antenna is illuminated by an interrogator.

3. The RFID tag of claim 2 wherein the reactive circuit is an open circuit.

4. The RFID tag of claim 1 wherein the antenna has a main element and at least one parasitic element.

5. The RFID tag of claim 1 wherein the antenna comprises a patch antenna.

6. The RFID tag of claim 1 wherein the at least one circuit comprises at least four circuits and the at least four circuits are adapted to emit a quadrature amplitude modulation (QAM) signal from the RFID tag.

7. A passive backscatter radio frequency identification (RFID) tag, comprising:
an antenna;
an electrical switch;
a first circuit element having a first impedance;
a second circuit element having a second impedance; and
the switch adapted to switch from an electrical connection between the antenna and the first circuit element to an electrical connection between the antenna and the second circuit element when the RFID tag is illuminated by an RFID interrogator such that the RFID tag emits a predetermined pattern of signals when illuminated by an RFID interrogator, the pattern of signals corresponding to a device signature of the RFID tag.

8. The RFID tag of claim 7 wherein the antenna is of an antenna type that emits radio frequency backscatter when the antenna is terminated by an open circuit and the antenna is illuminated by an interrogator.

9. The RFID tag of claim 7 wherein the antenna has a main element and at least one parasitic element.

10. The RFID tag of claim 7 wherein the antenna comprises a non-dipole antenna.

11. The RFID tag of claim 7 wherein the antenna comprises a patch antenna.

12. The RFID tag of claim 7 wherein the first and second circuit elements have distinct reactances, the distinct reactances adapted to modulate a phase of an illumination signal from an RFID interrogator.

13. The RFID tag of claim 7 wherein the first and second circuit elements have distinct resistances, the distinct resistances adapted to modulate an amplitude of an illumination signal from an RFID interrogator.

14. The RFID tag of claim 1 wherein the first and second circuit elements have distinct resistances and distinct reactances, the distinct resistances and reactances adapted to modulate both an amplitude and a phase of an illumination signal from an RFID interrogator.

15. A method of impedance modulation of a passive backscatter radio frequency identification (RFID) tag, the method comprising:
receiving a wireless input signal into an antenna of an RFID tag, the antenna operatively connected to a switch;
switching the switch between a first circuit having a first impedance and a second circuit having a second impedance such that an output signal from the antenna is modulated both in a predetermined amplitude and a predetermined phase, the modulation in both the predetermined amplitude and the predetermined phase corresponding to a device signature of the RFID tag; and
emitting the output signal from the RFID tag.

16. The method of claim 15 wherein the first and second circuits are both substantially lossless, the impedances of the lossless circuits corresponding to the predetermined phase.

17. The method of claim 16 further comprising switching the switch between a plurality of circuits, each having an element selected from the group consisting of an open circuit, a short circuit, an inductive circuit, and a capacitive circuit.

18. The method of claim 15 wherein the antenna has a main element and at least one parasitic element.

19. The method of claim 18 wherein at least one of the first and second circuits dissipates power, such that the dissipation corresponds to the predetermined amplitude.

20. The method of claim 15 further comprising switching the switch between the first and second circuits and a third circuit having a third impedance and a fourth circuit having a fourth impedance.

21. The method of claim 20 further comprising generating a quadrature amplitude modulation (QAM) signal.

22. A machine-implemented method of discerning a radio frequency identification (RFID) tag among non-RFID tag clutter, the method comprising:
receiving a wireless signal into an antenna, the wireless signal including an emitted signal from an RFID tag and clutter;
estimating an amplitude and phase of the signal in two or more distinct states;
estimating an amplitude and phase of the clutter; and
subtracting the clutter from the received signal.

23. The method of claim 22 wherein the estimating an amplitude and phase of the signal in two or more distinct states comprises:
computing an estimate of a low state of the RFID tag; and
computing an estimate of a high state of the RFID tag.

24. The method of claim 23 further comprising:
setting first phase shift states at the tag;
determining whether a phase difference between the computed estimates of the low and high states of the RFID tag is discernable; and
setting second phase shift states at the tag based on a determination that the phase difference between the computed estimates of the low and high states of the RFID tag is not discernable.
